(19) United States
(12) Patent Application Publication
(10) Pub. No.: US 2016/0130115 A1
(43) Pub. Date: May 12, 2016

(54) RETRACTABLE OVERHEAD ACCESS PLATFORM FOR MACHINE ROOM LESS ELEVATOR SYSTEMS

(71) Applicant: Richard C. Blaska, San Francisco, CA (US)

(72) Inventor: Richard C. Blaska, San Francisco, CA (US)

(21) Appl. No.: 14/536,027

(22) Filed: Nov. 7, 2014

(51) Int. Cl. B66B 5/00; B66B 11/02

(52) U.S. Cl. CPC B66B 5/0087; B66B 11/0246

(57) ABSTRACT

A retractable platform for use in a machine room less elevator system is disclosed. The retractable platform includes a vertical support and a collapsible platform. The vertical support has a mounting end for mounting to a top surface of an elevator car and a support end disposed opposite the mounting end. The collapsible platform has a first end for pivotally mounting to a hoistway wall, and a detachable end for detachably engaging the support end of the vertical support.

### TECHNICAL FIELD

The disclosure herein relates to elevator services and structures, and more specifically to a retractable platform for machine room less elevator systems.

### BACKGROUND

Machine room less (MRL) elevators are becoming more widespread in multi-story buildings. As the name suggests, the elevator system functions without a machine room to house bulky controller equipment. Instead, the equipment may be secured to a top portion of a wall of the hoistway, or in another less obtrusive area. Since no machine room is employed, an MRL requires significantly smaller space in the building.

One problem with MRL's involves accessing the controller equipment for maintenance operations. One proposal involves mounting a permanent platform to the top of an elevator car. Positioning the car at the top of the hoistway places the permanent platform near the equipment, allowing a technician access. While such a platform may prove useful in certain applications, the added weight to the car may require larger control equipment to adequately raise and lower the heavier car.

### BRIEF DESCRIPTION OF THE DRAWINGS

Embodiments of the disclosure are illustrated by way of example, and not by way of limitation, in the figures of the accompanying drawings and in which like reference numerals refer to similar elements and in which:

FIG. 1 illustrates a slightly elevated perspective view of one embodiment of a retractable access platform in a partially extended state.

FIG. 2 illustrates a side view of the retractable access platform of FIG. 1.

FIG. 3 illustrates a side view of the retractable access platform, similar to FIG. 2, but in a retracted state.

FIG. 4 illustrates further detail of a safety switch mechanism associated with the retractable access platform of FIGS. 1-3.

FIG. 5 illustrates a flowchart of steps for one embodiment of a method of accessing an overhead area in an MRL utilizing the retractable access platform of FIGS. 1-4.

### DETAILED DESCRIPTION

Embodiments of elevator systems, retractable platforms and associated methods are disclosed herein. In one embodiment, a retractable platform for use in a machine room less elevator system is disclosed. The retractable platform includes a vertical support and a collapsible platform. The vertical support has a mounting end for mounting to a top surface of an elevator car and a support end disposed opposite the mounting end. The collapsible platform has a first end for pivotally mounting to a hoistway wall, and a detachable end for detachably engaging the support end of the vertical support.

In a further embodiment, a machine room less elevator system is disclosed. The machine room less elevator system includes an elevator car having an external top surface and a vertical support mounted to the external top surface. The vertical support has a support end disposed opposite the mounting end. A collapsible platform having a first end pivotally mounts to a hoistway wall, and has a detachable end for detachably engaging the support end.

In yet another embodiment, a method of accessing an overhead area associated with a machine room less elevator system is disclosed. The method includes positioning an elevator car proximate control equipment mounted adjacent an elevator hoistway. A retractable platform is extended from a retracted state proximate a hoistway wall, to an extended horizontal state from the hoistway wall. A maintenance worker may then exit the elevator car and access a distal end of the platform via a vertical ladder mounted to a top surface of the elevator car. A top portion of the vertical ladder detachably engages the extended collapsible platform.

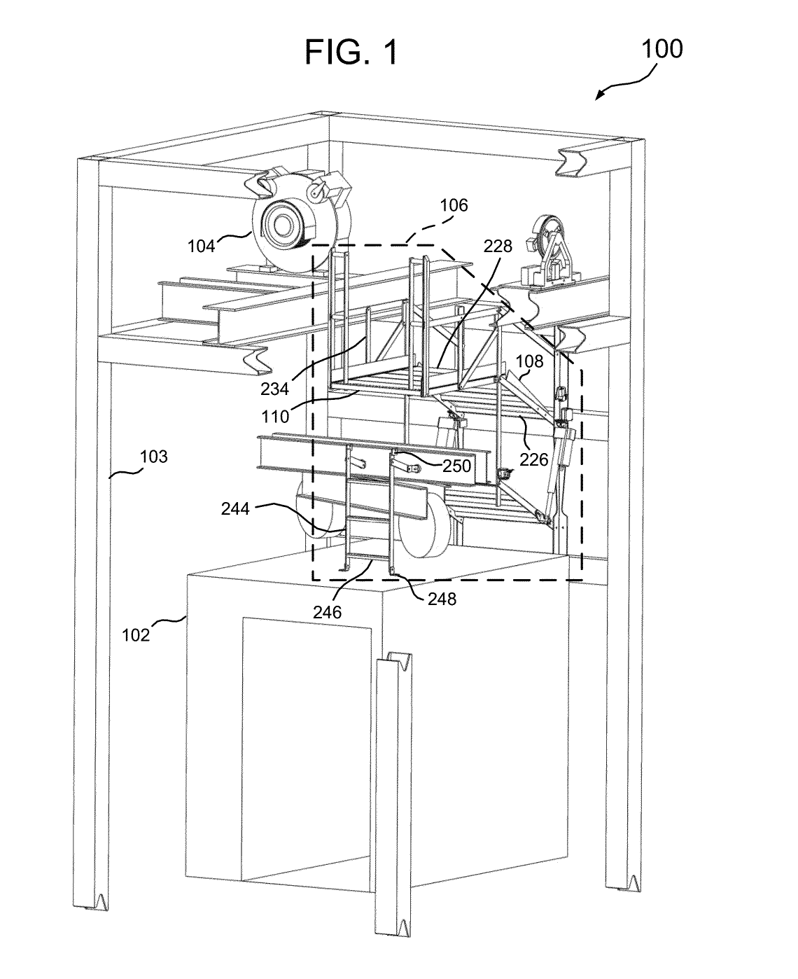

Referring to FIG. 1, one embodiment of a machine room less (MRL) elevator system, generally designated 100, employs a suspended elevator car 102 for vertically traversing a hoistway. The hoistway is generally a vertical opening constrained within a hoistway rail frame 103. Control equipment 104, located at the top of the hoistway and proximate the maximum allowable height of the elevator car, provides the lifting means to move the car up and down through the hoistway. The control equipment 104 is configured such that it can be mounted within the hoistway, thus conserving space within the building that would otherwise be dedicated to the elevator system.

With continued reference to FIG. 1, to access the control equipment 104 for routine maintenance and repairs, the elevator system 100 employs a retractable platform 106. The retractable platform 106 is shown in FIG. 1 as midway between a retracted state and an extended state. For one embodiment, the retractable platform includes a collapsible portion 108 coupled to a distal cantilevered portion 110. In general, the retractable platform 106 is stored in a retracted mode within the hoistway, out of the way of the operating elevator car 102. During maintenance, in an extended mode, the retractable platform 106 provides a secure work area proximate the control equipment 104 that is accessible from the elevator car 102. Adding negligible weight to the elevator car, the retractable platform minimizes any additional load placed on the control equipment to ensure that the control equipment maintains a relatively small profile.

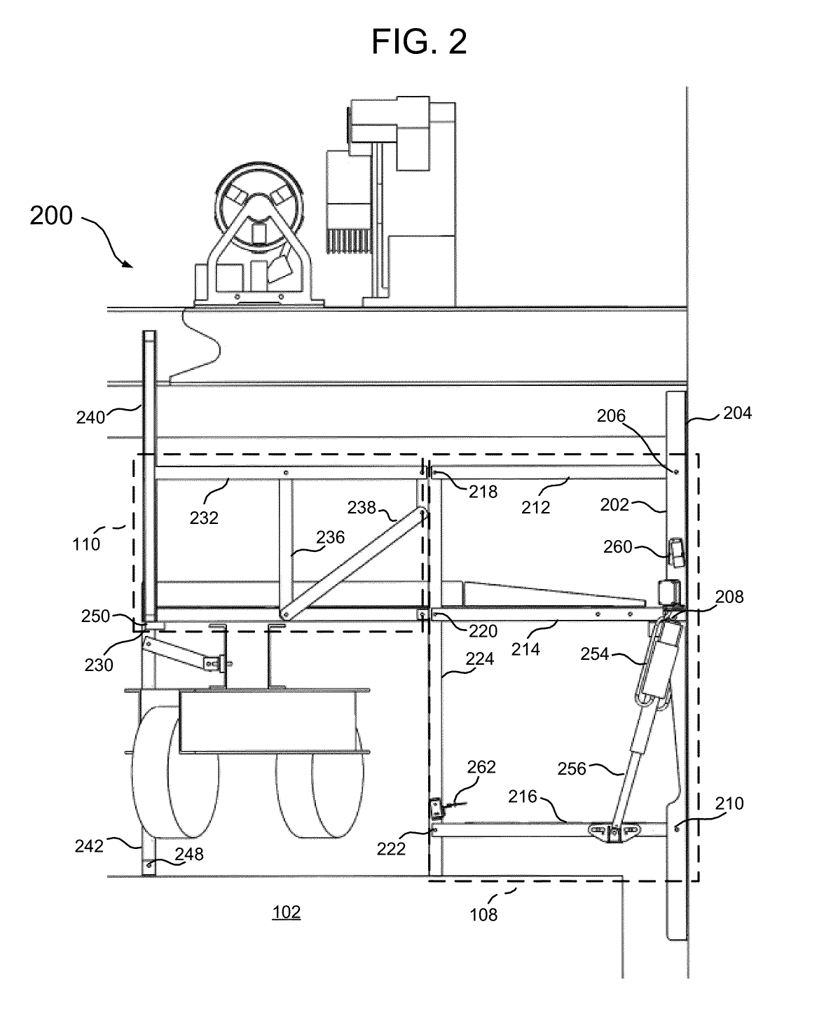

FIG. 2 illustrates a side view of one embodiment of the retractable platform 106 of FIG. 1 in further detail. The platform is shown in an extended state in order to illustrate the various structural features. Further, for purposes of brevity, while one side of the platform is being described in detail, the opposite side of the platform is formed similarly. As noted above, the retractable platform 106 includes a collapsible portion 108. A first side of the collapsible portion includes a vertically disposed base member 202 mounted to a back wall 204 of the hoistway. The base member 202 includes multiple pivot joints, at 206, 208, and 210. The pivot joints each couple to corresponding pivot arms 212, 214, and 216, with the other ends of the pivot arms terminating in respective distal pivots 218, 220 and 222 that are formed in a medial support member 224. A second side of the collapsible portion is formed symmetrical with the first side, and is spaced-apart from the first side via a plurality of lateral slats 226 (FIG. 1). The slats cooperate to form a portion of a deck 228 (FIG. 1). The collapsible portion 108 thus forms a scissors-like sub-assembly.

With continued reference to FIGS. 1 and 2, the cantilevered portion 110 of the retractable platform 106 extends from the distal end of the collapsible portion 108, and terminates at a distal support end, at 230. A first rectangular frame 232 bounds one side of a cantilevered distal end of the deck 228 (FIG. 1), while a second rectangular frame 234 (shown in FIG. 1, but not FIG. 2) bounds the opposite side. A pair of support brackets 236 and 238 provide rigidity to the first rectangular frame 232 with a matching pair of brackets also provided on the second frame. To provide ease of ingress and egress, an elevated handrail 240 is provided at the far distal end of the first rectangular frame.

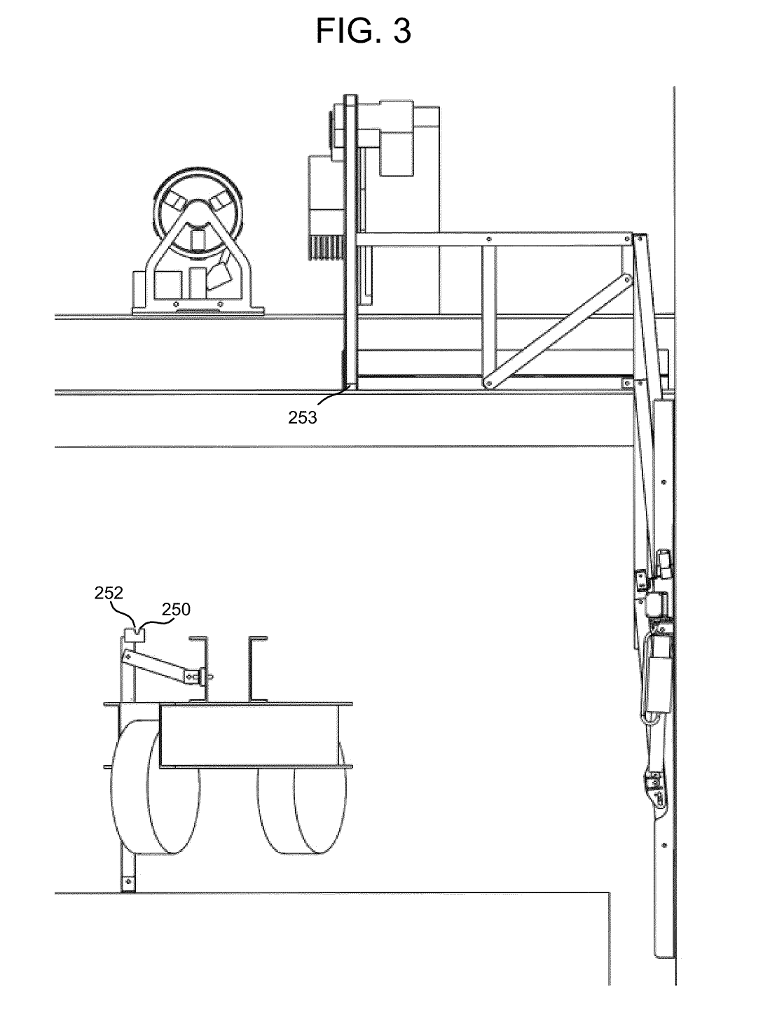

Further referring to FIGS. 1 and 2, to support the distal end of the cantilevered portion 110, the elevator car 102 mounts a short vertical ladder 242. The ladder includes a pair of spaced apart stub stiles or rails 244 (FIG. 1), and multiple steps 246 (FIG. 1) secured between the stiles to allow a worker to gain a height equivalent to the height of the platform. The ladder includes leg mounts 248 that are fixed to the top of the elevator car 102, and support mounts 250 that engage the distal support end 230 of the cantilevered portion 110 of the retractable platform. For one embodiment, shown more clearly in FIG. 3 with the retractable platform in a retracted state, the support mounts 250 are formed with guide slots 252 that complementally engage similarly formed tabs 253 in the platform distal support end 230. Since only the ladder 242 is mounted to the elevator car 102, minimal additional weight is added to the car, thus minimizing any further load on the control equipment during normal elevator lift operations.

With continued reference to FIG. 2, to retract and extend the retractable platform 106, one or more actuators 254 are mounted to the base member 202, and pivotally coupled to the lowermost pivot arm 216. Each cylinder includes a piston arm 256 that, when actuated in a retraction mode, causes the lowermost pivot arm 216 to rotate towards the hoistway wall, causing the other pivot arms 212 and 214 to rotate the same way, thereby collapsing the collapsible portion of the retractable platform against the hoistway wall, as shown in FIG. 3. For one specific embodiment, two electrically-driven, gear reduction motored, final screw drive linear actuators propel and lock the retractable platform in place. The medial support member 224 remains vertical, thus cooperating with the pivot arms 212, 214 and 216 to generate a scissors-like action when retracted. The collapsible portion 108 may be extended by merely actuating the piston arm 256 of the actuator 245 in an extension mode, thereby rotating the pivot arms 212, 214 and 216 outwardly away from the hoistway wall. While an electric linear drive actuator is described above, any form of actuator may be employed to extend and retract the retractable platform 106.

For one embodiment, the retractable platform 106 includes a safety switch mechanism that shuts off power to the control equipment, thereby keeping the elevator car stationary when the retractable platform is not fully retracted against the hoistway wall. The safety switch mechanism includes a fixed receptacle component 260 mounted to the base member 202, and electrically coupled to the electric power system that provides power to the elevator car 102. A plug component 262 mounts to the medial support member 224 and is positioned such that when the platform is fully retracted, the plug engages the receptacle, making contact with the receptacle to restore power to the elevator car 102.

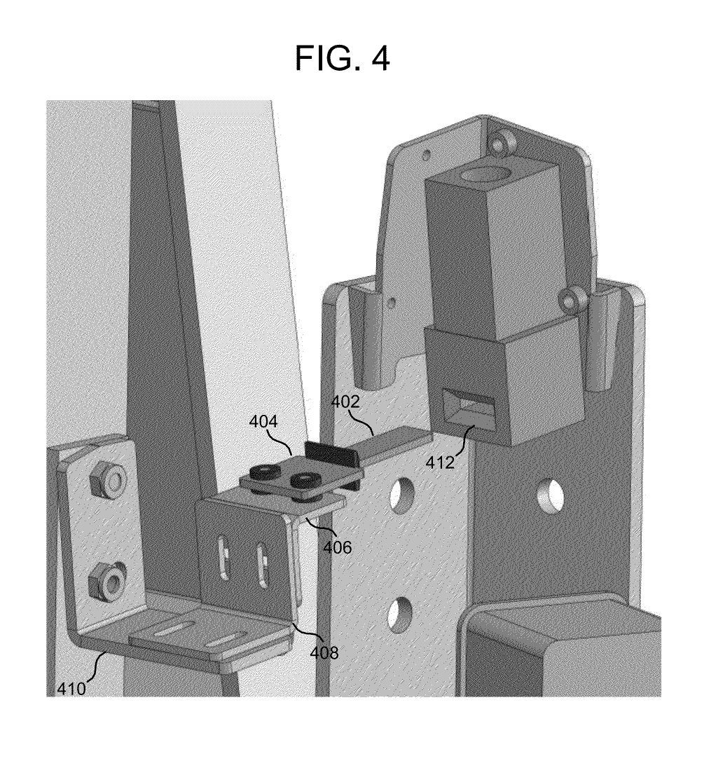

FIG. 4 illustrates further detail for specific embodiments of the receptacle component 260 and plug component 262. For one embodiment, the plug component is formed as a thin rectangular metal finger 402 that extends longitudinally from a flat base plate 404. The base plate mounts to a series of adjustable angle-irons 406, 408 and 410 that orient the plug component to the proper alignment for engaging the receptacle component when the retractable platform is fully retracted.

With continued reference to FIG. 4, for one embodiment, the receptacle component 260 includes a rectangular opening 412 formed to complementally receive the rectangular metal finger 402. Contacts (not shown) within the receptacle component provide respective respective “open” and “closed” states to correspondingly enable or disable power to the elevator car lifting means, depending on whether the retractable platform is fully retracted. Power to the elevator car lifting means is to be disabled unless the retractable platform rests fully in its retracted state.

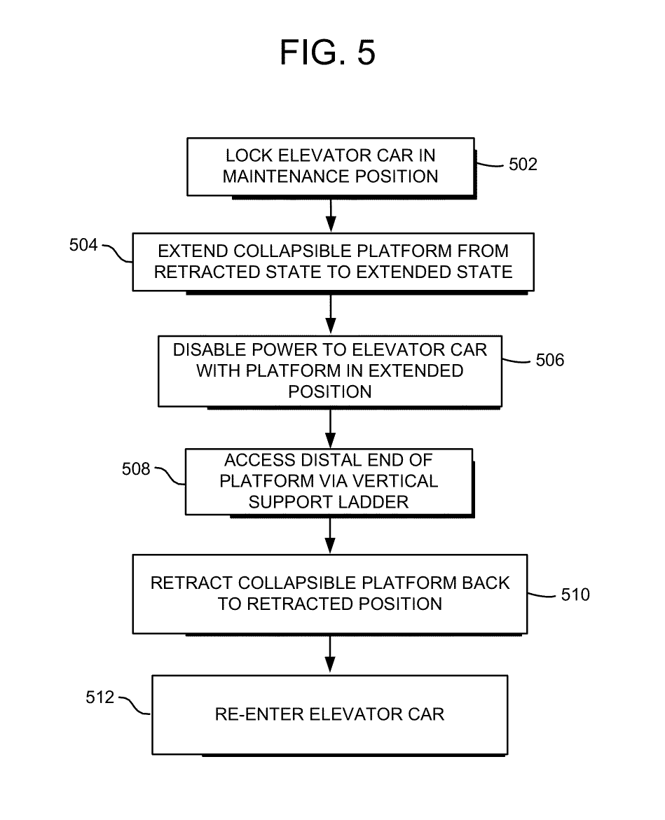

In operation, and referring to FIG. 5, maintenance operations for the MRL elevator may be carried out by an elevator technician who first accesses the hoistway via a “hoistway access” procedure. This generally involves taking the elevator car to a top landing served by the elevator and operating a dedicated keyed switch to operate the “hoistway access” control function. The technician may then step out into a hallway to operate a second key switch that lowers the car with the hoistway door in an open position. With the car lowered, the technician may then step onto the roof, or canopy, of the elevator car and close the hoistway doors. Disposed atop the elevator car is an operating station that allows the technician to operate the elevator car at slow speed. The technician may then run the car to the highest point in the hoistway that the car can travel, to a predetermined set maintenance height. The car may then be locked, at step 502, in the maintenance position with, for example, steel pins or bars that structurally interface with the hoistway frame rails.

Further referring to FIG. 5, with the elevator car locked into its maintenance position, a limit switch circuit (not shown) may be activated, enabling power to the retractable platform. The technician may then activate a keyed switch to extend the retractable platform from its retracted state to a fully extended state, at step 504. Extension of the platform involves powering the actuator to extend its piston arm, causing the lateral arms to pivot outwardly away from the back hoistway wall. As the collapsible portion of the platform begins to extend, the metal finger of the plug component disengages from the receptacle, causing power to the elevator car lifting means to be disabled, at step 506. When the collapsible portion of the platform extends to a fully horizontal position, the distal end of the cantilevered portion of the platform will engage the top mounts of the vertical support ladder. Once the platform engages the ladder, the entire length of the platform will be supported, and ready for access by the technician, at step 508.

With continued reference to FIG. 5, having access to the retractable platform enables the technician to reach critical portions of the control equipment utilized by the elevator system. Once any repair or maintenance work is finished, the technician may step off the platform back onto the car canopy, and activate the platform so that it returns to its retracted state, at step 510. Once fully retracted, the safety switch mechanism engages, enabling restoration of power back to the elevator car lifting means. The technician may then remove the steel pins securing the car to the hoistway rails, and may lower the car back to a position to access the hallway. The technician may then disengage the hoistway access function, raise the car back to normal operating height, and re-enter the car.

Those skilled in the art will appreciate that the embodiments described above provide an efficient and cost-effective way to provide access to MRL elevator control equipment with minimal impact to the control equipment capabilities. The collapsible nature of the platform enables storage against the hoistway wall during normal operations in a manner that doesn't affect the ability of the elevator car to raise and lower normally.

While the disclosure herein has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

We claim:

1. A retractable platform for use in a machine room less elevator system, the retractable platform comprising:
a vertical support having a mounting end for mounting to a top surface of an elevator car and a support end disposed opposite the mounting end;
a collapsible platform having a first end for pivotally mounting to a hoistway wall, and a detachable end for detachably engaging the support end.

2. The retractable platform according to claim 1, where:
in an extended state, the collapsible platform detachable end engages the support end of the vertical support; and
in a retracted state, at least a portion of the collapsible platform collapses vertically adjacent the hoistway wall.

3. The retractable platform according to claim 1, wherein the vertical support comprises a ladder.

4. The retractable platform according to claim 1, further including a linear actuator having one end pivotally coupled to the collapsible platform, and an opposite end fixed to the hoistway wall.

5. The retractable platform according to claim 1, further comprising a switch to cut power to the elevator car when the collapsible platform is not fully in the retracted state.

6. The retractable platform according to claim 1, wherein the collapsible platform comprises:
a collapsible portion; and
a cantilevered horizontal platform portion having one end pivotally coupled to the collapsible portion, and a distal end for engaging the support end of the vertical support.

7. The retractable platform according to claim 6, wherein the cantilevered horizontal platform portion remains in a horizontal orientation in both the retracted and extended states.

8. The retractable platform according to claim 7, wherein the cantilevered horizontal platform portion includes a platform base, and spaced-apart riser bars disposed longitudinally parallel with the platform base, at a predetermined height with respect to the platform base.

9. A machine room less elevator system comprising:
an elevator car having an external top surface and a vertical support mounted to the external top surface, the vertical support having a support end disposed opposite the mounting end; and
a collapsible platform having a first end pivotally mounted to a hoistway wall, and a detachable end for detachably engaging the support end.

10. The machine room less elevator system according to claim 9, where:
in an extended state, the collapsible platform detachable end engages the support end of the vertical support; and
in a retracted state, at least a portion of the collapsible platform collapses vertically adjacent the hoistway wall.

11. The machine room less elevator system according to claim 9, where:
the vertical support comprises a ladder.

12. The machine room less elevator system according to claim 9, further including:
a linear actuator having one end pivotally coupled to the collapsible platform, and an opposite end fixed to the hoistway wall.

13. The machine room less elevator system according to claim 10, further including:
a switch to cut power to the elevator car when the collapsible platform is not fully in the retracted state.

14. The machine room less elevator system according to claim 10, wherein the collapsible platform includes:
a collapsible portion; and
a cantilevered horizontal platform portion having one end pivotally coupled to the collapsible portion, and a distal end for engaging the support end of the vertical support.

15. The machine room less elevator system according to claim 14, wherein the cantilevered horizontal platform portion remains in a horizontal orientation in both the retracted and extended state.

16. The machine room less elevator system according to claim 14, wherein the cantilevered horizontal platform portion includes a platform base, and spaced-apart riser bars disposed longitudinally parallel with the platform base, at a predetermined height with respect to the platform base.

17. A method of accessing an overhead area associated with a machine room less elevator system, the method comprising:
positioning an elevator car proximate control equipment mounted proximate an elevator hoistway;
exiting the elevator car;
extending a collapsible platform from a retracted state proximate a hoistway wall, to an extended horizontal state from the hoistway wall;
accessing a distal end of the platform via a vertical ladder mounted to a top surface of the elevator car, a top portion of the vertical ladder detachably engaging the extended collapsible platform.

18. The method according to claim 17, further comprising:
cutting power to the elevator car when the collapsible platform is not in a fully retracted state.

19. The method according to claim 17, wherein extending the collapsible platform includes activating a linear actuator to extend the collapsible platform to the extended state.

20. The method according to claim 17, further comprising:
retracting the collapsible platform back to a proximate location with respect to the hoistway wall; and
re-entering the elevator car.
